(19) United States
(12) Patent Application Publication
(10) Pub. No.: US 2015/0021982 A1
(43) Pub. Date: Jan. 22, 2015

(54) DIRECT CURRENT ELECTRICAL GENERATING SYSTEM INCLUDING A PLURALITY OF DIRECT CURRENT ELECTRICAL GENERATING MODULES EACH HAVING AN ELECTROMECHANICAL SWITCH

(71) Applicant: EATON CORPORATION, CLEVELAND, OH (US)

(72) Inventors: THOMAS J. SCHOEPF, Whitefish Bay, WI (US); Charles John Luebke, Hartland, WI (US); Peter J. Theisen, West Bend, WI (US); Steven Christopher Schmalz, Franklin, WI (US)

(21) Appl. No.: 13/945,037

(22) Filed: Jul. 18, 2013

(51) Int. Cl. H02J 3/00

(52) U.S. Cl. CPC H02J 3/00
USPC 307/2; 307/77

(57) ABSTRACT

A system includes a power line, a control line, and a plurality of direct current electrical generating modules. Each of the direct current electrical generating modules is electrically connected to the power line and the control line and includes an electromechanical switch structured to interrupt power flowing through the power line. A control module is electrically connected to the control line and is structured to electrically control the electromechanical switch of each of the direct current electrical generating modules via the control line.

### BACKGROUND

1. Field

The disclosed concept relates generally to direct current electrical generating systems, and in particular, to photovoltaic systems.

2. Background Information

It is known to provide circuit breakers or fuses at a combiner box to electrically disconnect an entire string of photovoltaic (PV) modules in a PV system. However, even if the string of PV modules is electrically disconnected at the combiner box, the PV modules will continue to generate power if they are illuminated. When the wiring in the string or PV module is compromised, this can create a fire hazard as well as a shock hazard to firefighters or service personnel.

FIG. 1 shows a power system 10 including a string 11 of series connected PV modules 12. A switch 13 is provided in parallel with each of the PV modules 12 and is operable to short the corresponding PV module 12 whenever there is a fault in the module or string wiring. Although shorting a PV module 12 removes the voltage across the PV module 12, the PV module 12 is still subject to internal current flow and the possibility of an internal series arc fault.

There is room fir improvement in direct current electrical generating systems.

### SUMMARY

These needs and others are met by aspects of the disclosed concept which provide a system including a plurality of direct current electrical generating modules electrically connected to a power line, each direct current electrical generating module including an electromechanical switch structured to interrupt power flowing through the power line.

In accordance with aspects of the disclosed concept, a system comprises: a power line; a control line; a plurality of direct current electrical generating modules, each of the direct current electrical generating modules being electrically connected to the power line and the control line and including an electromechanical switch structured to interrupt power flowing through the power line; and a control module electrically connected to the control line and structured to electrically control the electromechanical switch of each of the direct current electrical generating modules via the control line.

In accordance with other aspects of the disclosed concept, a system comprises: a power line; a power line control transmitter electrically connected to the power line and structured to transmit a control signal through the power line; and a plurality of direct current electrical generating modules, each of the direct current electrical generating modules being electrically connected to the power line and including an electromechanical switch structured to interrupt power flowing through the power line and a power line control receiver structured to receive the control signal transmitted through the power line and to control operation of the electromechanical switch based on the received control signal.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram in schematic form of a photovoltaic system,

FIG. 2 is a block diagram in schematic form of a power system including a string of direct current electrical generating modules (DC EGMs) electrically connected to a power line and a control line in accordance with an example embodiment of the disclosed concept;

FIG. 3 is a block diagram in schematic form of a DC EGM in accordance with an example embodiment of the disclosed concept;

FIG. 4 is a block diagram in schematic form of a power system including a string of DC EGMs electrically connected to a power line and a control line in accordance with an example embodiment of the disclosed concept;

FIG. 5 is a block diagram in schematic form of a DC EGM in accordance with an example embodiment of the disclosed concept;

FIG. 6 is a block diagram in schematic form of a DC EGM including a power supply circuit in accordance with an example embodiment of the disclosed concept;

FIG. 7 is a block diagram in schematic form of a power system including a power line control transmitter and a string of DC EGMs electrically connected to a power line in accordance with an example embodiment of the disclosed concept;

FIG. 8 is a block diagram in schematic form of a DC EGM including a power line control receiver in accordance with an example embodiment of the disclosed concept;

FIG. 9 is a block diagram in schematic form of a power system including an arc fault detector (AFD) in accordance with an example embodiment of the disclosed concept; and

FIG. 10 is a block diagram in schematic form of a power system including a sub-array shutdown switch in accordance with an example embodiment of disclosed concept.

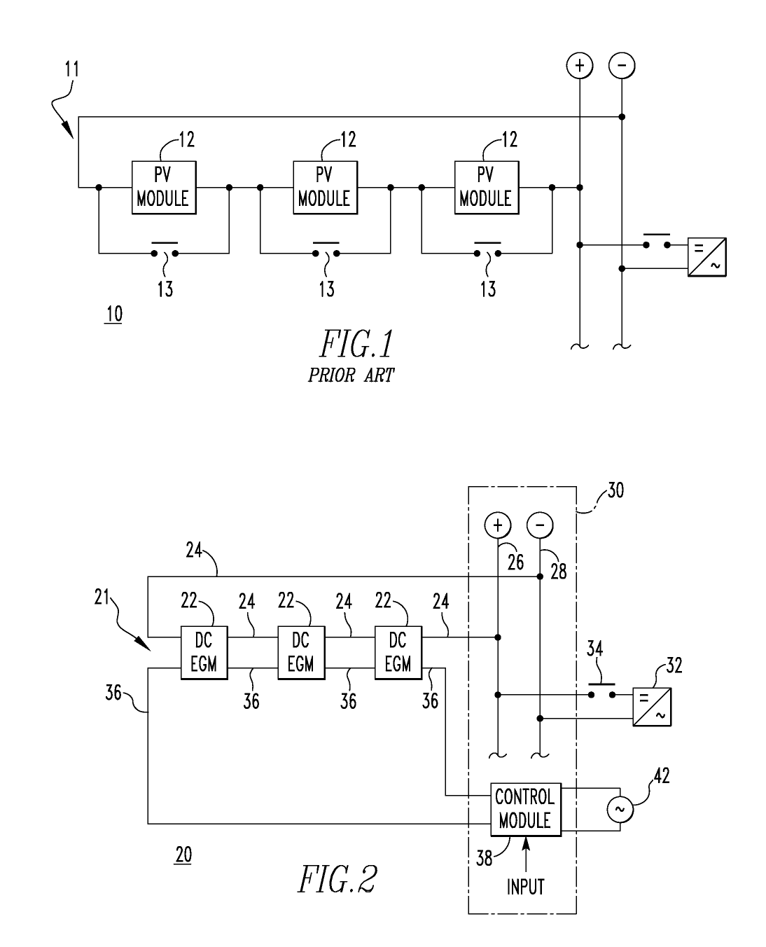

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

As employed herein, the term “number” shall mean one or an integer greater than one (Le., a plurality).

As employed herein, the term “string” shall mean a series electrical circuit connection of a plurality of electrical generating modules.

As employed herein, the term “combiner box” shall mean a box, an enclosure or another suitable structure where one or both ends of a plurality of strings can be fused and/or protected. A combiner box electrically combines in parallel direct current from a plurality of strings.

As employed herein, the term “direct current electrical generating module” (DC EGM) shall mean a photovoltaic (PV) electrical generating module, a battery or a fuel cell.

As employed herein, the term “power line” shall mean a number of power conductors that electrically connect DC EGMs on a string in series between a positive bus and a negative bus located at the feed end of the string.

As employed herein, the term “control line” shall mean a number of conductors that electrically connect DC EGMs on a string to a control module located at the feed end of the string.

As employed herein, the term “feed forward fault” shall mean a fault defined by a non-zero forward current and a corresponding voltage that is significantly lower than Voc (e.g., without limitation, a voltage less than about 20% of open circuit voltage) or Vmpp (voltage at the maximum power point). For example, a feed forward fault can indicate an external short toward the feed (inverter) end of a string.

The disclosed concept is described in association with protection for PV circuits, although the disclosed concept is applicable to a wide range of DC applications, including for example and without limitation, relatively higher DC voltage circuits, such as wind power, hybrid vehicles, electric vehicles, marine systems and aircraft.

Referring to FIG. 2, a power system 20 (e.g., without limitation, a PV power system) includes a string 21 having a plurality of DC EGMs 22 (e.g., without limitation, PV modules). A number of power conductors 24 form a power line which electrically connects the DC EGMs 22 in series between a positive bus 26 and a negative bus 28 located at the feed end of the string 21. The positive bus 26 and the negative bus 28 are disposed in a combiner box 30 which is located at the feed end of the string 21. While one string 21 having three DC EGMs 22 is disclosed in FIG. 2, the disclosed concept is not limited thereto. It will be readily appreciated by one having ordinary skill in the art that any number of strings 21 may be electrically connected to the positive and negative busses 26,28 without departing from the scope of the disclosed concept. It will also be readily appreciated by one having ordinary skill in the art that any number of DC EGMs 22 may be electrically connected on each string 21 without departing from the scope of the disclosed concept.

Power system 20 further includes an inverter 32 electrically connected to the positive and negative busses 26,28. The inverter 32 converts direct current power received from the positive and negative busses 26,28 to alternating current power. A sub-array shutdown switch 34 is electrically connected between the inverter 32 and the positive bus 26. The sub-array shutdown switch 34 can be opened to interrupt current flowing between the inverter 32 and the positive bus 26. While this configuration is suitable for, for example and without limitation, a negatively grounded PV array, it should be appreciated that other configurations may be employed without departing from the scope of the disclosed concept. In one example embodiment, the sub-array shutdown switch 34 may be electrically connected between the inverter 32 and the negative bus 28. This configuration is suitable for, for example and without limitation, a positively grounded PV array. In another example embodiment, one sub-array shutdown switch 34 may be electrically connected between the positive bus 26 and the inverter 32 and another sub-array shutdown switch 34 may be electrically connected between the negative bus 28 and the inverter 32. This configuration is suitable for, for example and without limitation, an ungrounded PV array.

A number of conductors 36 forma control line that is electrically connected to each of the DC EGMs 22. The control line is also electrically connected to a control module 38 located at the feed end of the string 21. The control module 38 is structured to electrically control electromechanical switches 40 (FIG. 3) provided in each of the DC EGMs 22 via the control line.

The control module 38 is structured to receive an input signal INPUT and to control the electromechanical switches 40 based on the received input signal INPUT.

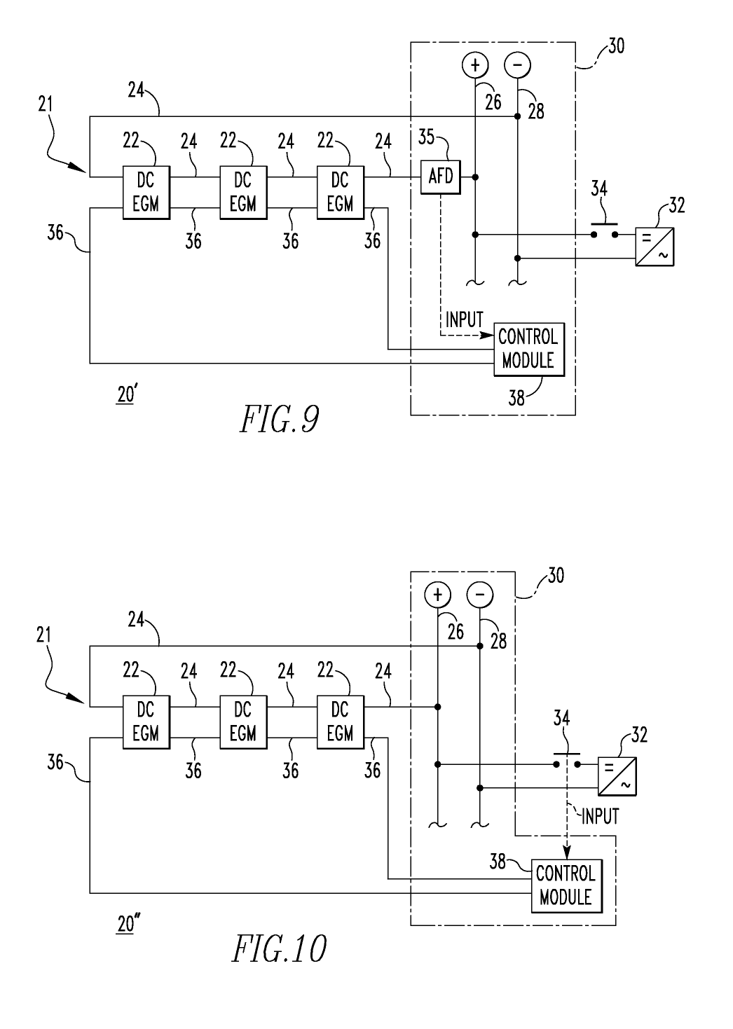

The input signal INPUT may be provided to the control module 38 by, for example and without limitation, an arc-fault detector and a sub-array shutdown switch. Turning briefly to FIG. 9, a power system 20′ includes an arc-fault detector (AFD) 35 which provides the input signal INPUT to the control module 38 and, turning briefly to FIG. 10, a power system 20″ includes a sub-array shutdown switch 34 which provides the

Referring back to FIG. 2, the control module 38 may also provide power to the electromechanical switches 40 via the control line. For example, the control module 38 may use power from an external power source 42 to supply power to the electromechanical switches 40. The external power source 42 may be an alternating current power source, as shown in FIG. 2. A direct current power source may also be used as the external power source 42 without departing from the scope of the disclosed concept.

Referring to FIG. 3, the DC EGMs 22 in accordance with an example embodiment of the disclosed concept each include the electromechanical switch 40, solar cells 42 and a junction box 44. The electromechanical switch 40 (e.g., without limitation, an electrically controlled relay) is electrically connected to the power line and the control line. Opening the electromechanical switch 40 interrupts power flowing through the power line and closing the electromechanical switch 40 allows current to flow through the power line. Opening and closing of the electromechanical switch 40 is electrically controlled by current flowing through the control line. The electromechanical switches 40 of each of the DC EGMs 22 are electrically connected in series with each other on the control line.

In some example embodiments of the disclosed concept, the electromechanical switches 40 are normally open and prevent current from flowing through the power line when no current is flowing through the control line. The electromechanical switches 40 then close and allow current to flow through the power line when a sufficient current flows through the control line. However, it is also contemplated that the electromechanical switches 40 can be normally closed when no current flows through the control line and then open when a sufficient current flows through the control line.

The electromechanical switches 40 may employ a relatively greater current to transition from an open position to a closed position than a current employed to maintain the electromechanical switches 40 in the closed position. In order to reduce the amount of power used to electrically control the electromechanical switches 40, the control module 38 may provide a first current on the control line to transition the electromechanical switches 40 from an open position to a closed position, and then provide a lesser second current to maintain the electromechanical switches 40 in the closed position.

The solar cells 42 are structured to harvest solar energy and convert it to direct current electrical power. The junction box 44 electrically couples the solar cells 42 to the power line such that the direct current electrical power from the solar cells 42 is provided to the power line.

While the electromechanical switch 40 and the junction box 44 are shown as separate components in FIG. 3, it is contemplated that the electromechanical switch 40 and junction box 44 may be integrally formed as one component.

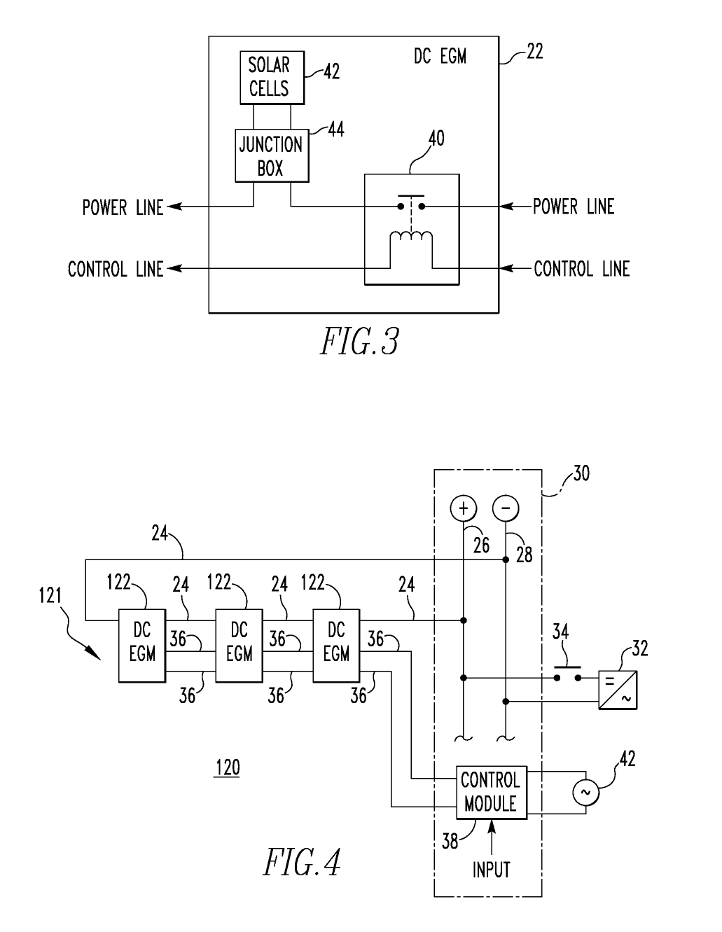

Referring to FIG. 4, a power system 120 in accordance with another example embodiment of the disclosed concept includes a string 121 having a plurality of DC EGMs 122. Power system 120 includes several components that are the same as or similar to components of power system 20. Therefore, further description of those same or similar components is omitted. However, power system 120 differs from power system 20 in that the control line enters, exits or passes through the DC EGMs 122 once on the way from the feed end of the string 121 to the remote end of the string 121 and again on the way from the remote end of the string 121 to the feed end of the string.

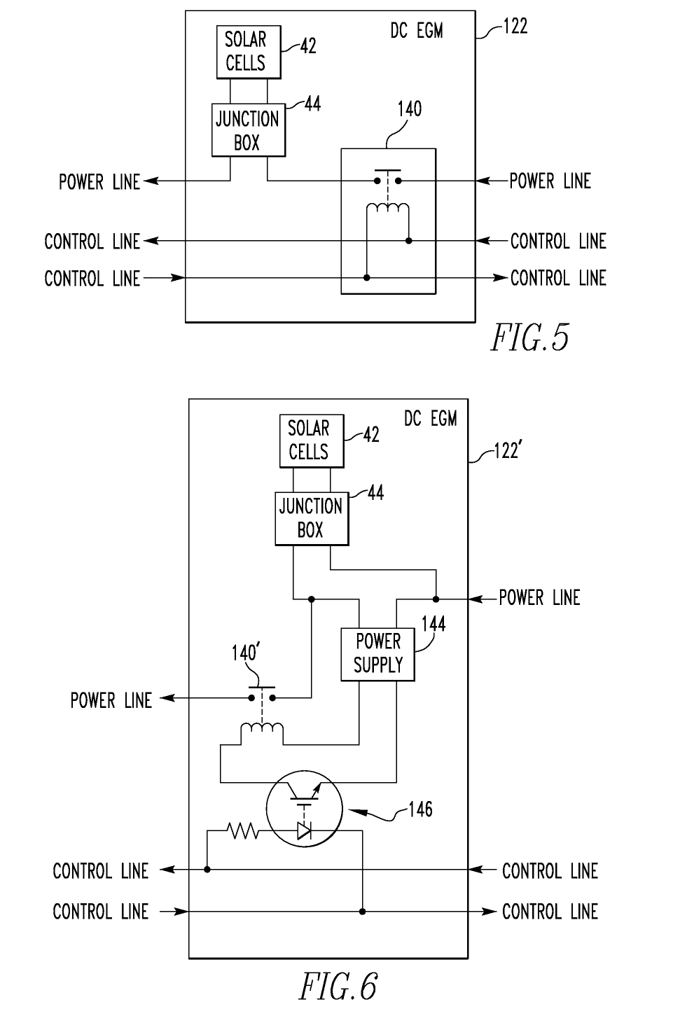

Turning to FIG. 5, the DC EGMs 122 each include an electromechanical switch 140 that is electrically connected to the power line and the control line. However, in contrast with the DC EGMs 22 included in power system 20 of FIG. 2, the DC

EGMs 122 included in power system 120 of FIG. 4 have electromechanical switches 140 that are electrically connected in parallel with each other on the control line. Thus, if there is a fault, for example, in the coil of electromechanical switch 140 in one of the DC EGMs 122, the electromechanical switches 140 in the other DC EGMs 122 will still be able to receive a signal from the control line.

Referring now to FIG. 6, a DC EGM 122′ in accordance with another example embodiment of the disclosed concept includes an electromechanical switch 140′, a power supply circuit 144 and a switching circuit 146 (e.g., without limitation, an optical coupler). DC EGM 122′ may be employed in power system 120 of FIG. 4 in place of DC EGM 122 without departing from the scope of the disclosed concept. The power supply circuit 144 is electrically connected to the power line and uses power from the power line to operate the electromechanical switch 140′. To this end, the power supply circuit 144 may include a direct current to direct current converter.

The switching circuit 146 is electrically connected to the control line and the power supply circuit 144. The switching circuit 146 is structured to permit current to flow through the power supply circuit 144 to the electromechanical switch 140 or to prevent current from flowing through the power supply circuit 144 to the electromechanical switch 140 based on a voltage on the control line. Thus, opening and closing of the electromechanical switch 140′ is electrically controlled via the control line.

The DC EGM 122 shown in FIG. 5 relies on the control module 38 of FIG. 4 to provide power on the control line to operate the electromechanical switch 140. In contrast, the DC EGM 122′ includes the power supply circuit 144 that uses power from the power line to operate the electromechanical switch 140′. Thus, if power system 120 employs DC EGMs 122′ instead of DC EGMs 122, the demand for power from the control module 38 can be reduced.

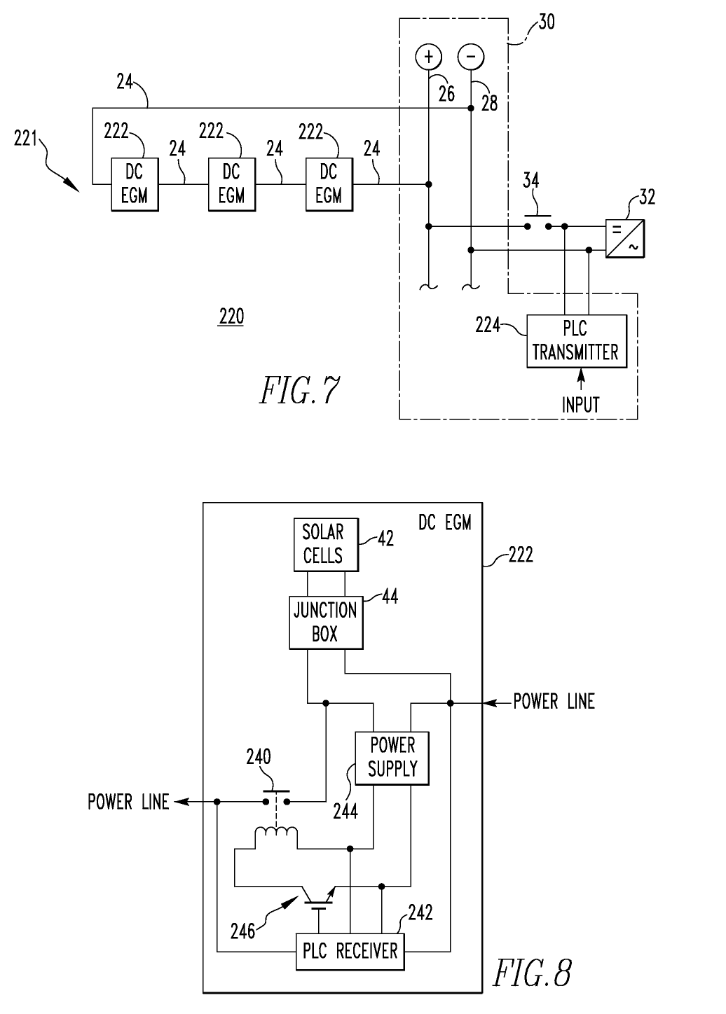

Referring now to FIG. 7, a power system 220 in accordance with another embodiment of the disclosed concept includes a string 221 having a plurality of DC EGMs 222. Power system 220 includes several components that are the same as or similar to components of power system 20. Therefore, further description of those same or similar components is omitted. However, power system 220 differs from power system 20 in that power system 220 does not include a separate control line. Rather, power system 220 includes a power line control (PLC) transmitter 224 electrically connected to the power line. The PLC transmitter 224 is configured to transmit encoded control signals on the power line based on a received input signal INPUT.

Turning to FIG. 8, the DC EGMs 222 each include a PLC receiver 242 that is electrically connected to the power line. The PLC receiver 242 is structured to receive and decode the encoded control signal from the power line and from the PLC transmitter 224 of FIG. 7. The PLC receiver 242 controls a switch 246 to open or closed based on the control signal. The PLC receiver 242 is also structured to allow the encoded control signal to pass through it to subsequent DC EGMs 222. Thus, when the The DC EGMs 222 each further include an electromechanical switch 240 and a power supply circuit 244. The power supply circuit 244 uses power from the power line to operate the electromechanical switch 240 based on the state of the switch 246. To this end, the power supply circuit 244 may include a direct current to direct current converter. The power supply circuit 244 is further structured to supply power to the PLC receiver 242.

The PLC receiver 242 is further structured to allow the encoded control signal to pass through it and continue on the power line to subsequent DC EGMs 222. Thus, when the electromechanical switch 240 is open, the encoded control signal can bypass the electromechanical switch 240 by passing through the PLC receiver 242. To this extent, the PLC receiver 242 may include a high pass filter structured to block direct current power from passing through it, but allow the encoded control signal to pass through it.

By employing the PLC transmitter 224 and the PLC receivers 242, power system 220 of FIG. 7 is able to electrically control electromechanical switches 240 without the need for a separate control line.

The power system 20′ of FIG. 9 is substantially the same as the power system 20 of FIG. 2 except that the input signal INPUT is provided by the AFD 35.

The power system 20″ of FIG. 10 is substantially the same as the power system 20 of FIG. 2 except that the input signal :INPUT is provided by the sub-array shutdown switch 34.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A system comprising:
a power line;
a control line;
a plurality of direct current electrical generating modules, each of the direct current electrical generating modules being electrically connected to the power line and the control line and including an electromechanical switch structured to interrupt power flowing through the power line; and
a control module electrically connected to the control line and structured to electrically control the electromechanical switch of each of the direct current electrical generating modules via the control line.

2. The system of claim 1, wherein the electromechanical switch of each of the direct current electrical generating modules is electrically connected to the control line in series with each of the other direct current electrical generating modules.

3. The system of claim 2, wherein the control module is configured to provide a first current through the control line to transition the electromechanical switch of each of the direct current electrical generating modules from an open position to a closed position and to provide a second current through the control line to maintain the electromechanical switch of each of the direct current electrical generating modules in the closed position; and wherein the first current is greater than the second current.

4. The system of claim 1, wherein the electromechanical switch of each of the direct current electrical generating modules is electrically connected to the control line in parallel with the electromechanical switch of each of the other direct current electrical generating modules.

5. The system of claim 1, wherein the electromechanical switch of at least one of the direct current electrical generating modules is an electrically controlled relay.

6. The system of claim 1, wherein each of said direct current electrical generating modules further includes a power supply circuit configured to use power from the direct current electrical generating module to operate the electromechanical switch.

7. The system of claim 6, wherein the power supply circuit includes a direct current to direct current converter.

8. The system of claim 6, wherein each of said direct current electrical generating modules includes a switching circuit electrically connected to the control line and the power supply circuit and is configured to permit current to flow through the power supply circuit based on a voltage of the control line.

9. The system of claim 8, wherein the switching circuit includes an optical coupler between the control line and the power supply circuit.

10. The system of claim 1, wherein the electromechanical switch of each of the direct current electrical generating modules is configured to permit power to flow through the power line when a current is flowing through the control line; and wherein, otherwise, the electromechanical switch of each of the direct current electrical generating modules is configured to interrupt power flowing through the power line when no current is flowing through the control line.

11. The system of claim 1, wherein each of said direct current electrical generating modules is a photovoltaic module.

12. The system of claim 1, wherein the control module is configured to receive an input from at least one of an arc fault detector and a sub-array shutdown switch and to control operation of the electromechanical switch of each of the direct current electrical generating modules based on the received input.

13. The system of claim 1, wherein the power line includes a first end and a second end; and wherein the first end of the power line is electrically connected to a positive bus in a combiner box and the second end of the power line is electrically connected to a negative bus in the combiner box.

14. A system comprising:
a power line;
a power line control transmitter electrically connected to the power line and structured to transmit a control signal through the power line; and
a plurality of direct current electrical generating modules, each of the direct current electrical generating modules being electrically connected to the power line and including an electromechanical switch structured to interrupt power flowing through the power line and a power line control receiver structured to receive the control signal transmitted through the power line and to control operation of the electromechanical switch based on the received control signal.

15. The system of claim 14, wherein each of the direct current electrical generating modules further includes a power supply circuit structured to use power from the direct current electrical generating module to operate the electromechanical switch.

16. The system of claim 15, wherein the power supply circuit includes a direct current to direct current converter.

17. The system of claim 15, wherein the power supply circuit provides power to the power line control receiver.

18. The system of claim 14, wherein the electromechanical switch of at least one of the direct current electrical generating modules is an electrically controlled relay.

19. The system of claim 14, wherein each of the direct current electrical generating modules is a photovoltaic module.

20. The system of claim 14, wherein the power line control transmitter is configured to receive an input from at least one of an arc fault detector and a sub-array shutdown switch and to control operation of the electromechanical switch of each of the direct current electrical generating modules based on the received input.

21. The system of claim 14, wherein the power line includes a first end and a second end; and wherein the first end of the power line is electrically connected to a positive bus in a combiner box and the second end of the power line is electrically connected to a negative bus in the combiner box.

22. The system of claim 14, wherein the power line control receiver is structured to allow the control signal to pass through it and continue on the power line when the electromechanical switch interrupts power flowing through the power line.
